(19) United States
(12) Patent Application Publication
(10) Pub. No.: US 2019/0108318 A1
(43) Pub. Date: Apr. 11, 2019

(54) Safety Center and Associated Equipment

(71) Applicant: Kenneth J. Bagan, Highland Park, IL (US)

(72) Inventor: Kenneth J. Bagan, Highland Park, IL (US)

(21) Appl. No.: 15/725,539

(22) Filed: Oct. 5, 2017

(51) Int. Cl. G06F 19/00

(52) U.S. Cl. CPC G06F 19/3418; H04W 4/008

(57) ABSTRACT

Embodiments of the invention provide a health kiosk system including, in an embodiment, a user-wearable device for interacting with the kiosk and with other remote entities to provide a workplace safety function. This function may include tracking user workplace safety parameters such as temperature, location and proximity to dangerous machines, conditions or areas. The wearable device periodically presents workplace safety messages to the user on a display of the device. These messages may be sourced from the kiosk or other source and may include workplace-specific safety messages, OSHA mandated postings, warnings, current status notifications and so on. In addition, non-safety messages such as plant event invitations and the like may also be interspersed among the safety messages.

### TECHNICAL AREA

The disclosure pertains to human health, wellness and safety and, more particular, to apparatus and methods for interactively and securely providing health, wellness and safety functions.

### BACKGROUND

Human health, wellness and safety continue to be important concerns, and yet regulators, insurers and other interested groups have not been able to create a system wherein all of these concerns are adequately met for a majority of people. This may be due to the fact that some users work, some users stay at home, some exercise at the leisure with little concern for safety and others may work in demanding jobs with safety concerns.

While the disclosed principles address some or all of the shortcomings described above via various embodiments, it will be appreciated that the solution of any particular problem is not to be taken as a limitation of any of the claims herein unless explicitly stated. Moreover, this background section is provided as an educational aid to the reader, and is not intended to be precisely representative of prior art. Thus, the inventor expressly hereby notes that the mention of any specific feature or aspect in the foregoing is not intended to be an indication that the feature or aspect is representative of actual prior art. While the disclosed principles address some or all of the shortcomings described above via various embodiments, it will be appreciated that the solution of any particular problem is not to be taken as a limitation of any of the claims herein unless explicitly stated. Moreover, this background section is provided as an educational aid to the reader, and is not intended to be precisely representative of prior art. Thus, the inventor expressly hereby notes that the mention of any specific feature or aspect in the foregoing is not intended to be an indication that the feature or aspect is representative of actual prior art.

### SUMMARY

In an embodiment, a kiosk system is provided for facilitating one or more health contests. The kiosk system includes a kiosk fixture having a seat for a user as well as a medical parameter measurement device affixed to the kiosk body for interaction by the user in measuring a medical parameter associated with the user. A biometric reader is included separate from the medical parameter measurement device for collecting at least one biometric parameter associated with the user, and a display screen is provided on the kiosk fixture and visible to the user. A processor within the kiosk is configured to compare the collected biometric parameter to a known biometric parameter of the user to verify user identity and, if user identify is verified, to share the measured medical parameter to one or more other similar kiosks systems to facilitate a health contest, and to cause the display screen to display standings associated with the health contest.

In another embodiment, a kiosk system is provided for tracking a user medical parameter. In this embodiment, the kiosk system includes a kiosk fixture with a seat for a user as well as a medical parameter measurement device affixed to the kiosk for interaction by the user in measuring a medical parameter associated with the user. A biometric reader separate from the medical parameter measurement device is provided for collecting at least one biometric parameter associated with the user, and a display screen on the kiosk fixture is provided so that it is visible to the user. A processor within the kiosk fixture compares the collected biometric parameter to a known biometric parameter of the user to verify user identity and, if user identify is verified, displays additional health information of the user via the display screen. The processor is also configured for receiving one or more safety guideline images and for periodically displaying the safety guideline images via the display screen. The safety messages may be modified to be displayed on the device screen.

The wearable device may autonomously display at least a subset of the safety guideline images sequentially. In a further embodiment, the user-wearable device is able to receive the safety guideline images wirelessly from the kiosk via a short-range wireless protocol or wirelessly from a remote source via a WiFi protocol independently of the kiosk processor. Relatedly, the user-wearable device may receive the safety guideline images wirelessly from the kiosk processor via a short-range wireless protocol and then cycle through the safety guideline images after the short-range connection is terminated.

In a further embodiment, the user-wearable device is GPS enabled to detect its position, and may also detect its proximity to another user-wearable device. The user-wearable device may alert the wearer to a potential collision based on detecting a proximity to the other user-wearable device that is closer than a predetermined threshold. Relatedly, the user-wearable device may provide an alert to the user or a third party recipient if the device location is an unauthorized or dangerous area.

In yet a further embodiment, the user-wearable device is configured to detect a user temperature and to alert the user (and/or a third party) if the user's temperature goes outside of a predetermined temperature range. For this purpose, an armpit sensor may be linked to the user-wearable device for detecting user temperature.

Similarly, in a related embodiment, the user-wearable device is configured to detect an ambient temperature and to alert the user or a third party if the ambient temperature goes outside of a predetermined temperature range.

The user-wearable device may detect that it is being worn and may wirelessly notify a recipient, such as a warehouse supervisor of this status, e.g., to track resources and manage personnel and attendance.

In a further embodiment, the user-wearable device is configured to wirelessly link to a mobile cellular device carried by the user and to communicate to a remote recipient via the mobile cellular device.

In another embodiment, a user-wearable device is provided having a display and being configured to receive safety guideline images and to autonomously display at least a subset of the safety guideline images sequentially to the user. The user-wearable device may receive the safety guideline images wirelessly from a health kiosk via a short-range wireless protocol or wirelessly from a remote source via a WiFi protocol independently of the kiosk. In either case, the device may store and then cycle through the safety guideline images whether or not it is in communication with another machine or device.

Other features according to various embodiments of the invention will be discussed in the examples below.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic diagram of a kiosk usable within embodiments of the invention;

FIG. 2 is a schematic diagram of the network operating environment of the kiosk within an embodiment of the invention;

FIG. 3 is a schematic diagram of a security-enhanced biometric kiosk unit according to an embodiment of the invention;

FIG. 4 is a schematic diagram of a non-biometric entertainment-enhanced kiosk unit according to an embodiment of the invention;

FIG. 5 is a schematic diagram of a kiosk system including wearable device, usable within embodiments of the invention; and

FIG. 6 is a is a schematic diagram of the network operating environment of the kiosk within the embodiment of the invention shown in FIG. 5.

### DETAILED DESCRIPTION

As discussed above, certain embodiments of the invention pertain to biometric measurement devices coupled to a wide area network such as the Internet or other communications infrastructure and/or network. The link to the network may be implemented by way of wired or wireless connections or a combination thereof, and while high speed connections such as DSL are preferred, slower connections may instead be used. The physical structure and features of a biometric kiosk usable within embodiments of the invention was described in detail in the related application referenced above, and that description is incorporated by reference and will thus not be repeated at length herein.

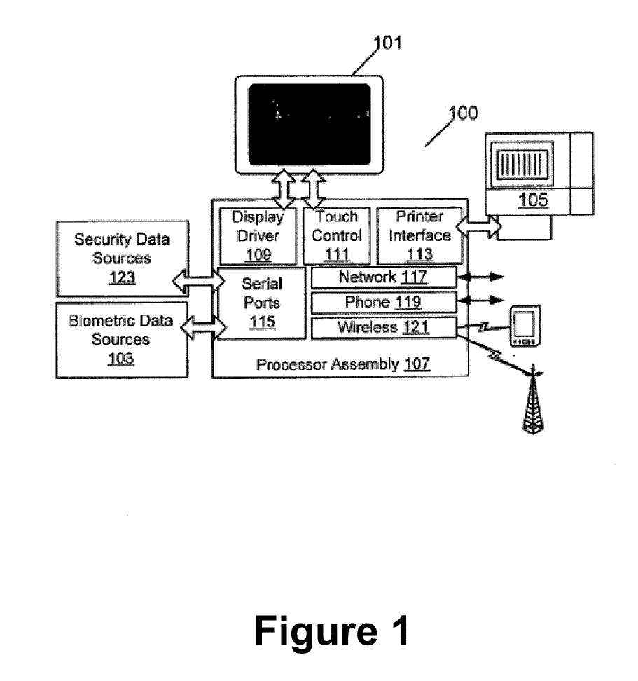

FIG. 1 is a schematic diagram of a kiosk usable within embodiments of the invention. The kiosk 100 comprises biometric data sources 103 (e.g., blood pressure cuff and associated electronics, scale and associated electronics, etc.), a display 101 and a printer 105.

These elements 101, 103, 105 are linked, typically by wired connections, to a processor assembly 107. The display 101 interfaces with the processor assembly 107 via a display driver 109 and a touch control module 111. The touch control module 111 receives and processes touch screen inputs from the display 101. The biometric data sources 103 interfaces with the processor assembly 107 via serial ports 115. Finally, the printer 105 interfaces with the processor assembly 107 via a printer interface 113.

The processor assembly 107 also comprises data links to external data sinks/sources. For example, in the illustrated embodiment of the invention, the processor assembly 107 comprises a network communication module 117, a phone communication module 119, and a wireless communication module 121. As will be discussed in greater detail below, the wireless communication module 121 allows connectivity to a cellular network and/or to local wireless devices (e.g., a PDA or cell phone) via a short range protocol such as Bluetooth. The network communication module 117 provides connectivity (wired or wireless) to one or more networks such as a local area network (LAN) and the Internet.

In addition to the features and elements noted above, the kiosk 100 further comprises a plurality of security data sources 123 linked to kiosk 100 via the serial ports 115 or otherwise as appropriate. The security data sources 123 comprise equipment usable to gather user-identifiable information for purposes of user verification. This is important both to protect sponsors from fraud as well as to protect users from unauthorized access to their biometric or other data. The security data sources 123 may include one or more cameras for retinal scanning, face recognition, and visual record-keeping purposes (e.g., for potential verification of past test results), as well as a fingerprint scanner for additional security and cross-checking for validation.

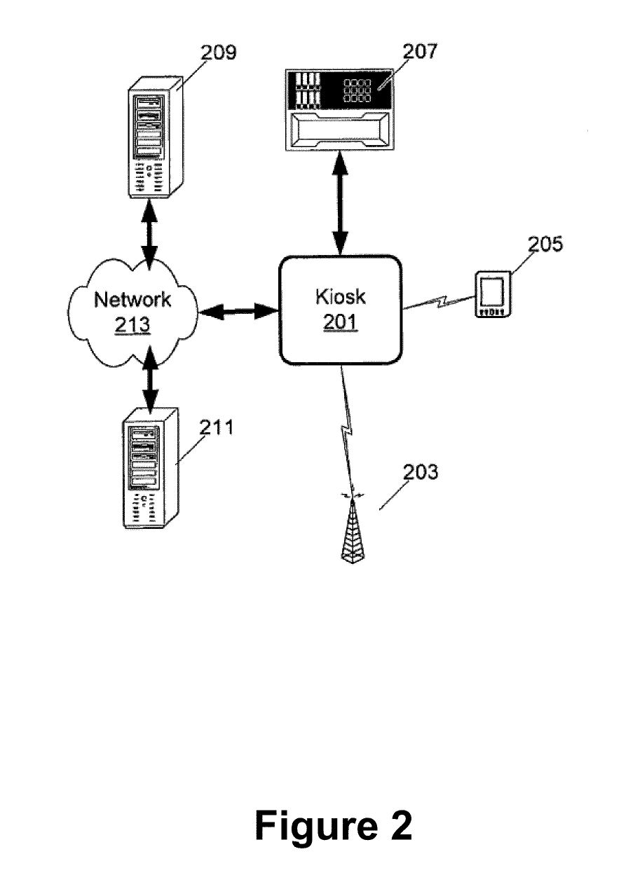

FIG. 2 is a schematic diagram of the network operating environment 200 of the kiosk within an embodiment of the invention. As illustrated, the kiosk 201 is communicably linked to a phone system 307, such as via ordinary phone lines. The kiosk 201 is also linked wirelessly to a cellular network 203 and a local wireless device 205, e.g., a Bluetooth equipped device. The local wireless link allows the user to use their own phone to communicate to or from the kiosk as well as to place a call through the kiosk to a customer service representative or advisor.

Finally, the kiosk 201 is linked via a network 213 to a number of networked data sources/sinks, e.g., servers 209, 211. In an embodiment of the invention, server 209 is an operator server of the company or other entity responsible for the kiosk. For example, LifeClinic® is the operator of kiosks that are placed in thousands of locations across the country. In this embodiment of the invention, the other server 211 is associated with a sponsor or other entity interested in receiving data from the kiosks as will be discussed in greater detail below.

The data transferred over the network links to/from one or both of servers 209, 211 to/from the kiosk 100 includes in an embodiment of the invention any or all of the communication indicated herein, including but not requiring: waiver, identity, readings, demographics and other data from the kiosk 100; instructions, video, communications, prior readings, and advertisements from the server(s) 209, 211.

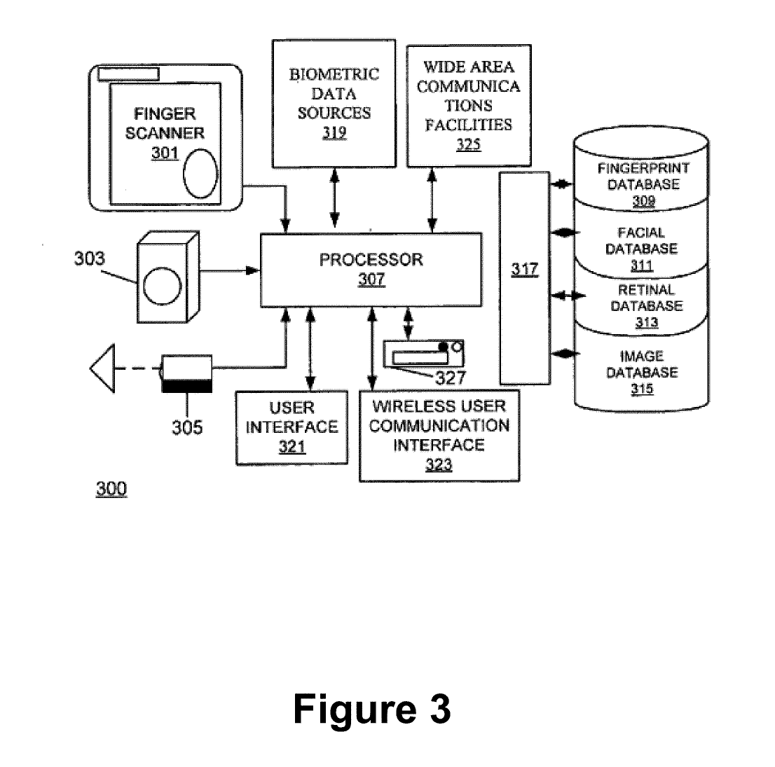

FIG. 3 is a more detailed schematic diagram of a security-enhanced biometric kiosk unit according to an embodiment of the invention, showing the components and logical units of the system rather than the physical interconnections. Although the illustrated exemplary kiosk architecture includes features for both user verification and user security, it will be appreciated that aspects of the invention may be implemented using either or both sets of features.

The security-enhanced biometric kiosk 300 comprises at its core a processor 307 linked to various other system components. The processor may be of any suitable type including one or more microprocessors, programmable logic controllers, and so, and may be implemented within a personal computer, workstation, or other computing device, or may be integrated into the kiosk 100 in a customized form. Although the processor 307 is illustrated as being directly linked to individual components, it will be appreciated that the illustrated interconnections are exemplary. Components may be interconnected via other components and may also be interconnected by a common bus architecture.

As illustrated in FIG. 3, the processor 307 is linked to a set of verification input devices including, in the illustrate arrangement, a fingerprint scanner 301, a camera 303, and a retinal scanner 305. It will be appreciated that other types of verification devices may be used instead or in addition to those listed. Moreover, although the camera 303 and retinal scanner 305 are illustrated as separate components, they may share one or more components, e.g., optics, etc. As will be appreciated, commercial camera systems, both built in (e.g., in a lap top computer) and stand alone, exist that are capable of executing face tracking and face recognition tasks.

The fingerprint scanner 301, camera 303, and retinal scanner 305 are communicably linked to the processor 307. The processor 307 is similarly linked to a series of databases through a database interface 317. The illustrated databases include a fingerprint database 309, a facial feature database 311, a retinal feature database 313, and an image database 315. The processor 307 is also linked to other components of the kiosk including a user interface 321, such as a screen, speaker, keyboard, buttons, etc. Additional components include biometric data sources 319 for kiosks that measure such information. The biometric data gathered by sources 319 can include parameters such as user weight, blood pressure, pulse rate, body fat and blood oxygen, or other parameters as will be appreciated by those of skill in the art.

The processor 307 is further linked to a wireless communication interface 323. The wireless communication interface 323 provides a mechanism for wirelessly communicating with nearby electronic devices. For example, the wireless communication interface 323 is adapted in an embodiment of the invention to wirelessly call a user's cell phone and connect the user via wide area communications facilities 325 to a call center or emergency personnel. As will be discussed in greater detail below, this functionality allows a user to be connected to necessary personnel in the event of an abnormal biometric reading, such as an extremely high blood pressure reading. In this way, the user is given counseling and advice to facilitate appropriate treatment or explain any complications. The user may also call a number, e.g., a 1-800 or other toll-free number, to initiate a consultation or get answers to general questions.

The processor 307 may also be linked to a card reader 327. A user may apply for and acquire a health information card, e.g., a co-branded magnetic stripe card promoted by the owner/operator and a credit card company or other enterprise. At the time that the user applies for the card, they preferably supply their name and address and may also be asked to respond to other questions that are of significance with respect to marketing. At that time as well, the customer may also be asked to sign a waiver at the information desk whereby they agree that their name and/or other information can be used for promotional and/or advertising purposes by the owner operator, etc. At the time that the user signs for and obtains the card, they may also have their personal security parameters gathered, e.g., face scan, retina scan, fingerprint, and so on. The user is then given a bar coded or magnetic coded loyalty card that encodes or is linked to his or her identification, address, etc. It will be appreciated that the user may instead sign up for the service on-line via the interface and connectivity of the kiosk itself, or from a personal computer or other networked computing device (e.g., personal digital assistant, Internet-enabled cell phone, etc.). In this case, the waiver may either be executed electronically or may be printed, executed, and mailed. The user card may be the user's credit card or other card carrying encoded user-specific identifying information.

When the user subsequently uses the kiosk, they are asked to scan their bar code by the bar code reader. This allows the kiosk to retrievably store the user's readings and also to access the user's name, address, etc. for promotional purposes. A waiver may appear on the display at this time as well. In addition, the data provided by a gift card or a credit card may also provide a buying history of the user to allow customization of messages and advertising. For example, the kiosk could recommend products similar to those that the user had purchased recently. Additionally, the kiosk may provide customized coupons based on the user's demographic data (race, class, income, age, ethnic origin, language, location, dwelling type, family size/type, gender, occupation, etc.) or buying history.

The fingerprint scanner 301 operates in a manner familiar to those of skill in the art, either alone or in conjunction with processes executed on processor 307 or other component. The fingerprint scanner 301 obtains an image of a user's finger compares this image to pre-scanned images, e.g., in database 309, to determine the identity of the user by determining whether the patterns of ridges and valleys in the images match. Although the fingerprint scanner 301 may be of any suitable construction, it will be appreciated that fingerprint scanners generally utilize either optical or capacitive technologies.

Optical scanners generally employ a charge coupled device (CCD) to capture the print image. Typically, an analog-to-digital converter in the scanner system processes the analog electrical output of the CCD to generate a digital image. The fingerprint scanner may comprise a light source such as an LED array to facilitate image acquisition. Much like optical scanners, capacitive fingerprint scanners also generate an image of a fingerprint. However, rather than using photons, they employ changes in capacitance across the print. One advantage of capacitance type sensors is that they cannot be manipulated via an image of a fingerprint. Additionally, capacitive scanners can be made more compact than optical devices.

As noted above, the camera 303 can be used for either or both of image storage, i.e., for later verification, and face recognition. For image storage purposes, the camera 303 is linked via the processor 307 to an image database 315. A photograph of each user is obtained by the camera 303 and stored, e.g., in database 315, for later verification if needed.

For purposes of facial recognition, the camera 303 captures an image of the users face and uses this image to verify the user's identity. Human faces have certain distinguishable features or landmarks. For example, there are distinct dips and rises that make up different facial features. Depending upon the algorithm used, as many as 80 landmarks may be identified and used for recognition.

Examples of landmarks include the distance between a user's eyes, the width of a user's nose, depth of a user's eye sockets, shape or location of a user's cheekbones, shape or location of a user's jaw line, and the shape or location of a user's chin. Features of the landmark points are measured and translated to a unique numerical code or “faceprint” that represents the particular face. Pre-scanned faces, or related representations such as face prints, are stored in database 311 to facilitate later comparison for validation. Registration of a user's faceprint to be used for later verification may occur upon the user's first use of a kiosk system as described herein, or may be obtained elsewhere, e.g., at a registration desk.

The retinal scanner 305 obtains an image of the user's retina and compares this to prior scans, e.g. scans stored in database 313, to verify a user's identity. Retinal scanners are commercially available, and operate in a manner similar to that described above, i.e. by matching a retina of interest, or characteristics thereof, to a validation image of a retina or to characteristics of such an image.

It will be appreciated that other identity verification techniques may be used additionally or alternatively to verify a user's identity. Other techniques include, but are not limited to, voiceprint recognition, vein pattern recognition, iris recognition, etc.

While the databases 309, 311, 313, and 315 may be local to the kiosk, it is preferred that alternatively or additionally, there are databases that are accessible by the kiosk in question as well as other kiosks so that a user may access their information at any one of a global network of kiosks. Thus, the databases 309, 311, 313, and 315 are preferably stored or replicated at one or more central servers and may be downloaded periodically or as needed, or may be queried rather than downloaded.

The aforementioned security and verification features are important not only to prevent unauthorized access to a user's private data, but also to protect sponsors or affiliates from fraud. For example, it is important for kiosk sponsors and affiliates who provide incentives linked to user health to be able to verify that the user is indeed the person that they purport to be.

One area where significant incentives may be provided and hence where enhanced security will be important is the area of insurance incentives. In particular, insurers will enroll with a kiosk system host to receive user medical information from such kiosks and to provide targeted advertising and incentives through the kiosks. In particular, a user may use any one of the global network of kiosks to take a measurement of interest, e.g., weight, body fat percentage, or blood pressure, and this information will be transmitted to the enrolled insurer. In an embodiment of the invention, the kiosk displays a list of enrolled insurers to the user, and the user selects the appropriate company name.

If the user's current and prior measurements show a positive trend (e.g., losing body fat) at an acceptable rate (e.g., 2 pounds per week) or in an acceptable amount (e.g., 10 pounds), then the insurer will provide a reward to the user. Rewards can consist of rebates, gift cards, reduced insurance rates, and so on. Thus, users may be tempted to cheat to obtain the incentives, i.e., by having a friend in better health sit in as the user. To avoid fraud and cheating, it is important that the insurer be able to verify that the subscriber being rewarded has indeed made the appropriate improvements.

In an embodiment of the invention, the kiosk, whether providing health-related measurements or not, displays information of general interest to the user. For example, the kiosk may display a stock ticker or 5-day weather forecast.

Kiosks of the type described above can be used for a number of activities and interchanges that provide value to both the community and the sponsor or business supporting the machine. For example, the kiosk, whether or not it includes a biometric measurement facilities, can be used to provide entertainment such as via television or video. The entertainment content may be customized for the sponsor, e.g., a department store, or may be publicly available entertainment. In this embodiment of the invention, the entertainment provides a draw for customers who may not be interested in shopping or may be tired.

For examples, men accompanying women in a predominantly female-oriented store may prefer to rest at the kiosk. In an embodiment of the invention wherein the user identifies themselves by swiping a loyalty card, credit card, etc., the system can provide customized services. For example, if the system is able to access recent purchase history, it will supply appropriate coupons via the attached printer to encourage the user to avail themselves of the goods or services of the sponsor. More generally, a credit card or gift card's magnetic stripe may supply identity information both for customization of services and to track a user's biometric readings.

In this embodiment of the invention, the user may be presented with menu options to choose an activity. For example, a user may be asked to choose from sports scores, sports highlights, interviews, news, current affairs, exercise tips, etc. In another example of the invention, the kiosk provides one or more maps or informational items related to the store hosting the kiosk. Advertisements are run during these services and can be customized if the customer uses a personalized gift card or credit card.

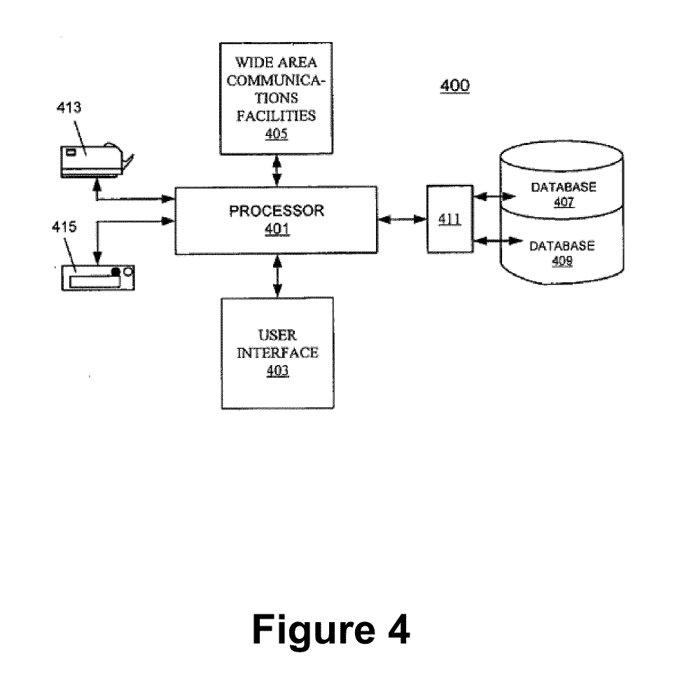

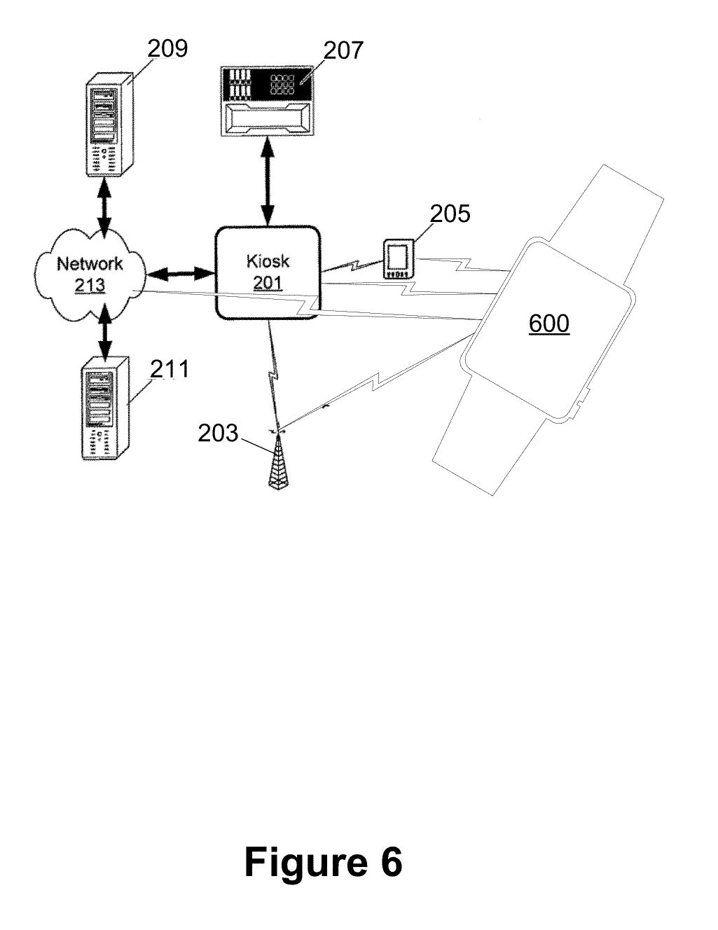

A schematic diagram of an exemplary kiosk that omits biometric measurement and information facilities but that provides entertainment information such as via television, video, etc., is illustrated in FIG. 4. The kiosk 400 is similar in some regards to that of FIG. 3, and includes a processor 401, a user interface 403, wide area communications facilities 405, and a set of databases 407, 409, linked to the processor 401 via a database interface 411. The kiosk 400 includes a printer 413, which may also be used in the kiosk 300 of FIG. 3. The kiosk 400 also includes a card reader 415. In overview, the non-biometric kiosk 400 as illustrated in FIG. 4 is usable to provide entertainment and advertising to users. The manner of operation according to a specific example will be given below by reference to the flow chart of FIG. 6.

Returning now to the system illustrated in FIG. 3, it was mentioned above that such a biometric measurement equipped kiosk can be used to obtain and provide biometric data of interest to a user and to provide an emergency alert to the user. In particular, certain biometric measurements can convey information sufficient to indicate whether the user may be in or about to enter a dangerous state. For example, blood pressure readings can indicate that a person is having, or is close to having, a stroke. In this case, the kiosk will call the user's cell phone automatically and connect the user to an emergency service, so that a paramedic may further diagnose and advise the user. This is especially useful for older users who may not be able to dial a help number. In particular, very high (or otherwise worrisome) readings cause the kiosk to connect the user's cell phone to the kiosk and then through to a call center representative for counseling. When communicating with the user's cell phone, the kiosk may target devices within a small enough radius to likely include the cell phone, e.g., 2 or 3 feet. The connection between the kiosk and the cell phone may be executed via Bluetooth or other suitable short-range wireless protocol.

In a further embodiment, the kiosk system 100 is configured to facilitate one or more health contests. The kiosk system includes a kiosk cabinet or fixture having a seat for a user as is common for kiosk health systems, as well as a medical parameter measurement device affixed to the kiosk body for interaction by the user in measuring a medical parameter associated with the user as shown in FIG. 1. A biometric reader is included separate from the medical parameter measurement device for collecting at least one biometric parameter associated with the user, and a display screen is provided on the kiosk fixture and visible to the user, also as shown in FIG. 1. The kiosk processor is configured to compare the collected biometric parameter to a known biometric parameter of the user to verify user identity and, if user identify is verified, to share the measured medical parameter to one or more other similar kiosks systems to facilitate a health contest, and to cause the display screen (FIG. 1) to display standings associated with the health contest.

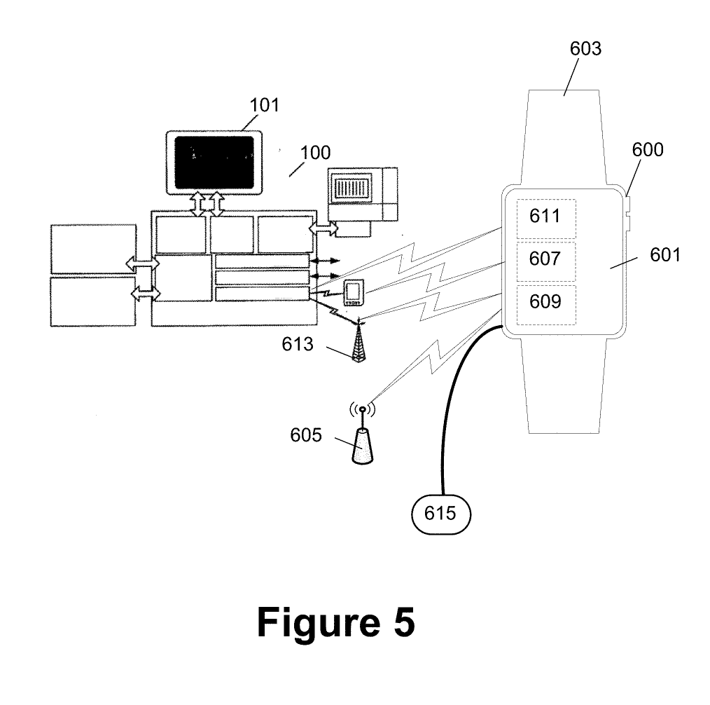

FIG. 5 is a schematic diagram of a kiosk system 600 much like that in FIG. 1, but also including a wearable device 600. In this embodiment, the kiosk system operates as above, e.g., tracking a user medical parameter and includes the standard known physical structures, e.g., a kiosk fixture or cabinet with a seat for a user, and is configured to operate in the same manner, e.g., with similar options. However, in this embodiment, the kiosk processor is further configured to receive one or more safety guideline images and periodically display the safety guideline images via the display screen.

In a further embodiment, the user-wearable device 600, e.g., a watch or band is also configured to receive the safety messages and display them on the device screen 601. The safety messages may be modified to be displayed on the device screen 601. The safety messages may include workplace safety messages, OSHA mandated postings, warnings, current status notifications and so on. In addition, non-safety messages such as plant event invitations and the like may also be interspersed among the safety messages.

The wearable device 600 may autonomously display at least a subset of the safety guideline images sequentially. In an embodiment, the user-wearable device 600 is configured to receive the safety guideline images wirelessly from the kiosk via a short-range wireless protocol such as Bluetooth. Alternatively or additionally, the device may be configured to receive the safety messages from a remote source via a wireless access point 605, a cellular system 613 or a mobile cellular device carried by the user. The wireless access point 605 may operate via a WiFi protocol or other suitable protocol.

Relatedly, the user-wearable device 600 may receive the safety guideline images wirelessly from the kiosk processor (FIG. 1) via a short-range wireless protocol and, in any event, cycle through the safety guideline images after the short-range connection is terminated.

In a further embodiment, the user-wearable device is GPS enabled via GPS module 609 to detect its position, and may also detect its proximity to another user-wearable device by comparing locations or by direct detection, e.g., via Bluetooth. The user-wearable device 600 may alert the wearer to a potential collision with another device-wearing user or their equipment based on detecting a proximity to the other user-wearable device that is closer than a predetermined threshold. Relatedly, the user-wearable device may provide an alert to the user or a third party recipient if the device location is an unauthorized or dangerous area.

In yet a further embodiment, the user-wearable device is configured via temperature module 607 to detect a user temperature and to alert the user (and/or a third party) if the user's temperature goes outside of a predetermined temperature range. For this purpose, an armpit sensor 615 may be linked to the user-wearable device 600 for detecting user temperature.

Similarly, in a related embodiment, the user-wearable device 600 is configured to detect an ambient temperature via ambient module 61 land to alert the user or a third party if the ambient temperature goes outside of a predetermined temperature range.

The user-wearable device may detect that it is being worn, e.g., by sensing touch or temperature, and may wirelessly notify a remote recipient, such as a warehouse supervisor of this status. In this may, an employer or manager may track resources and personnel and may also manage attendance. In a further embodiment, the user-wearable device 600 is configured to wirelessly link to a mobile cellular device carried by the user, as shown in FIG. 5, and to communicate to a remote recipient via the mobile cellular device.

As noted above, the kiosk system may track and display health contest results, e.g., among institutions or workplaces. In this connection, the wearable device 600 may display contest standings and results periodically or as requested by the user.

For completeness, FIG. 6 shows a schematic diagram of the network operating environment of the kiosk of FIG. 5. As can be seen, the wearable device 600 is linkable to the user mobile device, if available, and the kiosk itself, via a short range wireless protocol. Further the wearable device 600 is linkable via a midrange or cellular protocol to another network 213 or access point 203. In this way, the wearable device may execute communications in the most effective and efficient manner available in any situation.

It will be appreciated that preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A kiosk system for facilitating one or more health contests, the kiosk system comprising:
a kiosk fixture having a seat for a user thereon;
a medical parameter measurement device affixed to the kiosk body for interaction by the user in measuring a medical parameter associated with the user;
a biometric reader separate from the medical parameter measurement device for collecting at least one biometric parameter associated with the user;
a display screen on the kiosk fixture and visible to the user; and
a processor within the kiosk fixture configured to compare the collected biometric parameter to a known biometric parameter of the user to verify user identity and, if user identify is verified, for sharing the measured medical parameter to one or more other similar kiosks systems to facilitate a health contest, and to cause the display screen to display standings associated with the health contest.

2. A kiosk system for tracking a user medical parameter, the kiosk system comprising:
a kiosk fixture having a seat for a user thereon;
a medical parameter measurement device affixed to the kiosk body for interaction by the user in measuring a medical parameter associated with the user;
a biometric reader separate from the medical parameter measurement device for collecting at least one biometric parameter associated with the user;
a display screen on the kiosk fixture and visible to the user; and
a processor within the kiosk fixture configured to compare the collected biometric parameter to a known biometric parameter of the user to verify user identity and, if user identify is verified, for displaying additional health information of the user via the display screen, for receiving one or more safety guideline images and for periodically displaying the safety guideline images via the display screen.

3. The kiosk system in accordance with claim 2, further comprising a user-wearable device having a display and being configured to receive the safety guideline images and to autonomously display at least a subset of the safety guideline images sequentially.

4. The kiosk system in accordance with claim 3, wherein the user-wearable device is configured to receive the safety guideline images wirelessly from the kiosk processor via a short-range wireless protocol or wirelessly from a remote source via a WiFi protocol independently of the kiosk processor.

5. The kiosk system in accordance with claim 4, wherein the user-wearable device is configured to receive the safety guideline images wirelessly from the kiosk processor via a short-range wireless protocol and to then cycle through the safety guideline images after the short-range connection is terminate.

6. The kiosk system in accordance with claim 3, wherein the user-wearable device is GPS enabled to detect its position.

7. The kiosk system in accordance with claim 6, wherein the user-wearable device is configured to detect a proximity to another user-wearable device.

8. The kiosk system in accordance with claim 7, wherein the user-wearable device is configured to alert the wearer to a potential collision based on detecting a proximity to the other user-wearable device that is closer than a predetermined threshold.

9. The kiosk system in accordance with claim 3, wherein the user-wearable device is configured to detect a user temperature and to alert the user or a third party if the user's temperature goes outside of a predetermined temperature range.

10. The kiosk system in accordance with claim 9, further comprising an armpit sensor linked to the user-wearable device for detecting user temperature.

11. The kiosk system in accordance with claim 3, wherein the user-wearable device is configured to detect an ambient temperature and to alert the user or a third party if the ambient temperature goes outside of a predetermined temperature range.

12. The kiosk system in accordance with claim 3, wherein the user-wearable device is configured to detect that it is being worn and to wirelessly notify a recipient of this status.

13. The kiosk system in accordance with claim 12, wherein the user-wearable device is GPS enabled to detect its position and to provide an alert to the user or a third party recipient if the device location is an unauthorized or dangerous area.

14. The kiosk system in accordance with claim 1, wherein the safety messages are modified to be displayed on the device screen.

15. The kiosk system in accordance with claim 1, wherein the user-wearable device is configured to wirelessly link to a mobile cellular device carried by the user and communicate to a remote recipient via the mobile cellular device.

16. A system for tracking a user medical parameter, the system comprising a user-wearable device having a display and being configured to receive safety guideline images and to autonomously display at least a subset of the safety guideline images sequentially to the user.

17. The system in accordance with claim 16, wherein the user-wearable device is configured to receive the safety guideline images wirelessly from a health kiosk via a short-range wireless protocol or wirelessly from a remote source via a WiFi protocol independently of the kiosk.

18. The system in accordance with claim 17, wherein the user-wearable device is configured to receive the safety guideline images wirelessly from the kiosk via a short-range wireless protocol and to then cycle through the safety guideline images after the short-range connection is terminated.

19. The system in accordance with claim 16, wherein the user-wearable device is GPS enabled to detect its position.

20. The system in accordance with claim 19, wherein the user-wearable device is configured to detect a proximity to another user-wearable device.

21. The system in accordance with claim 20, wherein the user-wearable device is configured to alert the wearer to a potential collision when a proximity to the other user-wearable device is closer than a predetermined threshold.

22. The system in accordance with claim 18, wherein the user-wearable device is configured to detect a user temperature and to alert the user or a third party if the user's temperature goes outside of a predetermined temperature range.

23. The system in accordance with claim 22, further comprising an armpit sensor linked to the user-wearable device for detecting user temperature.

24. The system in accordance with claim 18, wherein the user-wearable device is configured to detect an ambient temperature and to alert the user or a third party if the ambient temperature goes outside of a predetermined temperature range.

25. The system in accordance with claim 18, wherein the user-wearable device is configured to detect that it is being worn and to wirelessly notify a recipient of this status.

26. The system in accordance with claim 25, wherein the user-wearable device is GPS enabled to detect its position and to provide an alert to the user or a third party recipient if the device location is an unauthorized or dangerous area.

27. The system in accordance with claim 16, wherein the safety messages are modified to be displayed on the device screen.

28. The system in accordance with claim 16, wherein the user-wearable device is configured to wirelessly link to a mobile cellular device carried by the user and communicate to a remote recipient via the mobile cellular device.
